(19) United States
(12) Patent Application Publication
(10) Pub. No.: US 2003/0147133 A1
(43) Pub. Date: Aug. 7, 2003

(54) Method and system for user guidance in scanning microscopy

(76) Inventor: Johann Engelhardt, Bad Schonborn (DE)

Correspondence Address: HOUSTON ELISEEVA, 4 MILITIA DRIVE, SUITE 4, LEXINGTON, MA, 02421, US

(21) Appl. No.: 10/379,162

(22) Filed: Mar. 3, 2003

Related U.S. Application Data
(63) Continuation of application No. 09/476,588, filed on Dec. 31, 1999.

(51) Int. Cl. G02B 21/36

(52) U.S. Cl. 359/368; 359/363; 359/385

(57) ABSTRACT

The invention discloses a system utilized in a scanning microscope and a method for providing user guidance. The system for providing user guidance comprises an illumination source for producing a light beam and optical means for shaping and guiding the light beam. A scanning device scans the light beam across a sample. At least one detector is used to detect the fluorescent or reflected light from the sample. The position signal of the light beam on the sample is also detected. A control and processing unit with digitizing means processes the intensity data received from a sample and generates an online representation of various image quality parameters to be observed by the user on a display of a computer.

### RELATED APPLICATIONS

This application is a Continuation of patent application Ser. No. 09/476,588 which was filed on Dec. 31, 1999 and is incorporated by reference herein in its entirety.

### FIELD OF THE INVENTION

The present invention generally relates to a method and system for user guidance in the field of scanning microscopy. More particularly, the invention relates to a user guidance system and method allowing an inexperienced user to operate a scanning microscope successfully.

### BACKGROUND OF THE INVENTION

In confocal microscopy a specimen is scanned with a focused laser beam. The focus of the laser beam is moved in a section plane of a specimen by tilting two scan mirrors around their respective axes. The axes of the scan mirrors are perpendicular to each other. For example one scan mirror diverts the laser light in the x-direction and the other scan mirror diverts the laser light in the y-direction. The intensity of the reflected or the fluorescent light is measured for each scanning point. Each measured intensity value relates to an x, y and z-position of the specimen, therefore, providing a user with a three-dimensional image of the specimen.

“Tutorial on Practical Confocal Microscopy and Use of the Confocal Test Specimen” by Victoria Centozone and James Pawley (the Handbook of Confocal Microscopy, edited by James B. Pawley, Plenum Press, New York, 1995, pp. 549-569) contains an overview of the parameters affecting the process of image capturing in confocal microscopy. To utilize a confocal microscope properly, it is necessary for a user to be familiar with basic concepts and principles of operation of a confocal microscope. Numerous parameters affecting the image quality and proper settings of a confocal microscope are essential to good image quality and have to be set by the user. Presently, no system furnishes a user with suggestions regarding automatic parameter settings of a confocal microscope providing an optimal parameter set.

### SUMMARY OF THE INVENTION

It is, therefore, an object of the present invention to provide a scanning microscope with a user guidance system allowing an inexperienced user to efficiently use the scanning microscope. The user guidance system enables a user to view optimal quality images in a short period of time. This object of the invention is achieved by a system for user guidance in scanning microscopy. The system comprises a control and processing unit having digitizing means for providing online digital data of scan signals. The signals are formed by fluorescent or reflected light from a sample. Additionally, a light beam scanning the sample generates a position signal. A control and processing means generated the relevant image quality parameters to be displayed to the user. The system also comprises computer means for image processing, and a display unit for displaying information about the relevant image quality parameters to the user.

It is also an object of the present invention to provide a scanning microscope with a user guiding system for allowing inexperienced users to efficiently use the scanning microscope after a short period of time. This object of the invention is accomplished by a scanning microscope with a user guidance system comprising an illumination source generating a light beam, optical means for shaping and guiding the light form the illumination source. Also provided is a scanning device for scanning a light beam across a sample and at least one detector registering fluorescent and/or reflected light from the sample. The system also comprises registration means for determining the position signal of the light beam on the surface of the sample, a control and processing unit with digitizing means for generating online digital signals of scan data. The signals are generated by fluorescent or reflected light from the sample, the signals including the position signal of the light beam on the surface of the sample. Control and processing means of the present invention provides online relevant image quality parameters, computer means performs data processing, and a display unit displays visualized information about the plurality of relevant image quality parameters.

Another object of the present invention is to provide a user guidance method enabling inexperienced users to operate a scanning microscope and obtain high quality images without the need to make adjustments to the microscope settings. This object is accomplished by a method comprising collecting sequential image data of a first and a second image of a sample, statistically processing the data independently of the image structure and location. The method further comprises calculating a plurality of relevant image quality parameters and using the calculated image quality parameters for subsequent image registration.

A further object of the present invention is to provide a user guidance method allowing inexperienced users to obtain high quality images in a confocal microscope without the need to make adjustments to the microscope settings. That object is accomplished by a guidance method comprising recording sequential image signals of a first and a second image of a sample, wherein the image signals correspond to fluorescent or reflected light from a sample. A related pixel position signal corresponds to a position of the scanning beam on the surface of the sample. The method further comprises online digitizing of the sequentially registered image signals, statistically processing the received data independently of the image structure and location, calculating a plurality of relevant image quality parameters and using the calculated image quality parameters for subsequent image registration.

In scanning microscopy a specimen is scanned with a suitably focused laser beam. The reflected or fluorescent light propagating from the specimen is detected by a suitable detector. Particularly in confocal scanning microscopy, there are many parameters affecting the quality of a resulting image, therefore, making it desirable to have a way to control such parameters to receive the optimal image result. Examples of such parameters are a bleaching rate of a sample, a bleaching rate of sample dyes, background noise, over- and undersampling, over- and underflow of detectors, saturation, a scanning rate, and the dimensions of the scanned part of the sample. Getting a perfect image in a scanning microscope is often a difficult task not only for an inexperienced microscope user, but also for a user with a lot of experience in operating such a microscope. When analyzing fluorescent samples, a user has to take into account that the fluorochromes of the specimen bleach when illuminated. Plus, the user has to avoid saturation effects occurring when the specimen is illuminated with a high intensity light beam.

The present invention displays the main image quality parameters, therefore helping inexperienced and experienced users to adjust interactively the optimal microscope settings. Such microscope settings may include the degree of noise in the image, the actual bleaching rate and the degree of saturation as well as the actual setting of the scanning speed, scanning rate, size of the scanned part of the specimen, over- or undersampling. The present invention utilizes the intensities of two sequentially taken images to determine important image quantity and quality parameters. For example, one possibility of such determination is to measure the bleaching rate by detecting and analyzing the shift of the center of the two intensity diagrams H(I₁) and H(I₂).

Another way of determining the bleaching rate is to plot a diagram of intensities with respect to the corresponding points of two different images. Intensity pairs (I₁,I₂) of a sample with no bleaching will fall on a straight line with a slope of 45°. Intensity pairs of a sample with bleaching will fall on a straight line having a higher slope. A straight line represents an ideal case unaffected by noise. In reality the intensity pair data (I₁,I₂) will be scattered around the ideal line. The distribution of the intensity pair data (I₁,I₂) in a cross section perpendicular to the ideal line allows the determination of the actual degree of noise. In most cases this distribution will be a Gaussor Poisson distribution.

To determine the saturation behavior of the specimen dyes, the illumination intensity setting will have to be changed after obtaining the first image. If the ratio of intensities corresponding to two different images stays the same, it means there is no saturation. If the intensity ratio changes, then it means that there is saturation and the degree of saturation can be calculated from the changes of the intensity ratio.

Over- and undersampling can be calculated from the chosen settings.

In one embodiment of the present invention, the calculated settings will be automatically saved and applied to forming subsequent images. In another embodiment of the invention various image quality parameters are displayed to a user, so that the user can utilize the displayed parameters to adjust the microscope settings. The displayed parameters are preferably presented to the user visualization in the form of graphical indicators, for example, such as a scroll-bar.

The user guidance method and system of the present invention use the approach of digitizing signals received from a specimen and from a detector as soon as possible in order to accelerate processing of the data by programmable digital logic (for example, a field programmable gate array FPGA). The advantage of the FPGA electronics is its ability to processing data up to a nanosecond accuracy in real time.

### BRIEF DESCRIPTION OF THE DRAWINGS

The subject matter of the present invention is described with reference to the embodiments shown in the following drawings.

FIG. 1 is a schematic illustration of a confocal microscope and a system for achieving three dimensional specimen images.

FIG. 2 is a schematic illustration of a calculation method for displaying the pixel intensity of sequential images in a histogram.

FIG. 3 is a schematic illustration of a calculation method comparing the frequency of pixel intensities of sequential images.

FIG. 4 is a schematic illustration of a method for determining the image noise.

FIG. 5 is a schematic illustration of an embodiment of a visual user interface.

FIG. 6 is a schematic illustration of an embodiment of the visual user interface in more detail.

FIG. 7 is a graph illustrating a cross talk between two detection channels.

### DETAILED DESCRIPTION OF THE INVENTION

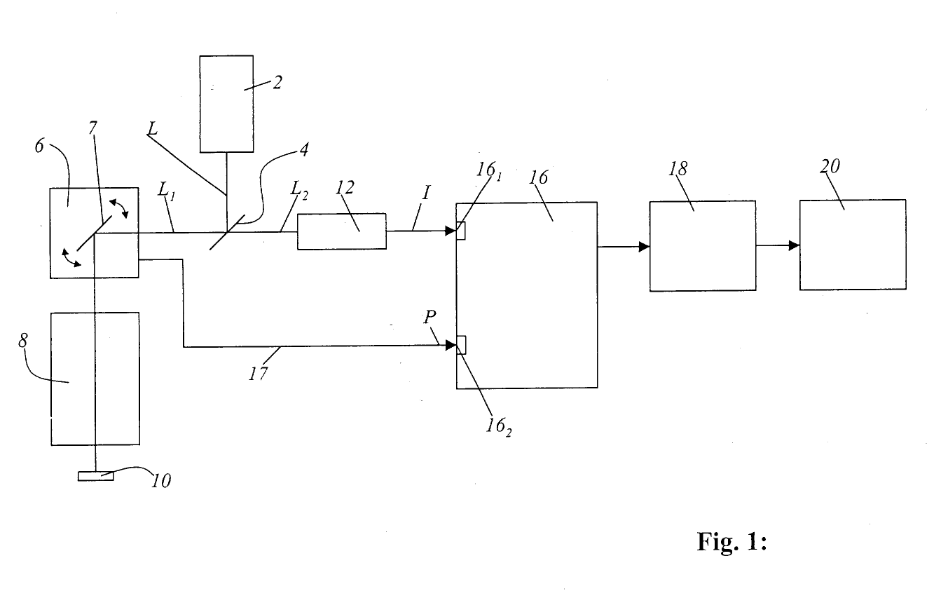

FIG. 1 shows a schematic illustration of a confocal microscope system reducing the complexity of parameter settings and image quality adjustments and eliminating the need of extensive use of the complex microscope user manuals. An illumination system 2 generates a light beam L. A beam splitter 4 divides the incident light beam L into a first path L₁ and into a second path L₂. The light from the illumination system is directed to a scanning device 6 along the first path L₁. Scanning device 6 comprises a scanning mirror system 7 moveable in such a way that the light propagating along the first path L₁ is scanned across a specimen 10. The light propagating along the first path L₁ passes through an optical system 8 before reaching specimen 10. The light reflected from the specimen travels along the first path L₁ back to beam splitter 4 and then to a first detector 12 positioned to receive the light reflected from the specimen 10. First detector 12 converts that light into a first electrical signal I, wherein the first signal I is proportional to the intensity of the light reflected from the specimen. A position signal P generated by scanning device 6 is fed to a second input port 162 via an electrical connection 17. The embodiment illustrated in FIG. 1 shows two different analog signals I and P which are fed to a control and processing unit 16 via ports 16₁ and 16₂, respectively. These distorted and disturbed incoming analog signals I and P are converted into corrected digital signals in control and processing unit 16. The digital signals are then sent to a computer 18 for image processing and for displaying an image on a display unit 20. Display unit 20 provides a user with a simultaneous visual presentation of the relevant image quality parameters, such as, for example, the bleaching rate of specimen 10, saturation behavior, over- an undersampling, pinhole-size, etc. Control and processing unit 16 is implemented with a plurality of FPGA-units (Field Programmable Gate Array). To implement online processing of scan signals, the analog signals I and P are digitized as soon as possible and the resulting digital data are processed by programmable digital logic, allowing real time processing with a nanosecond accuracy.

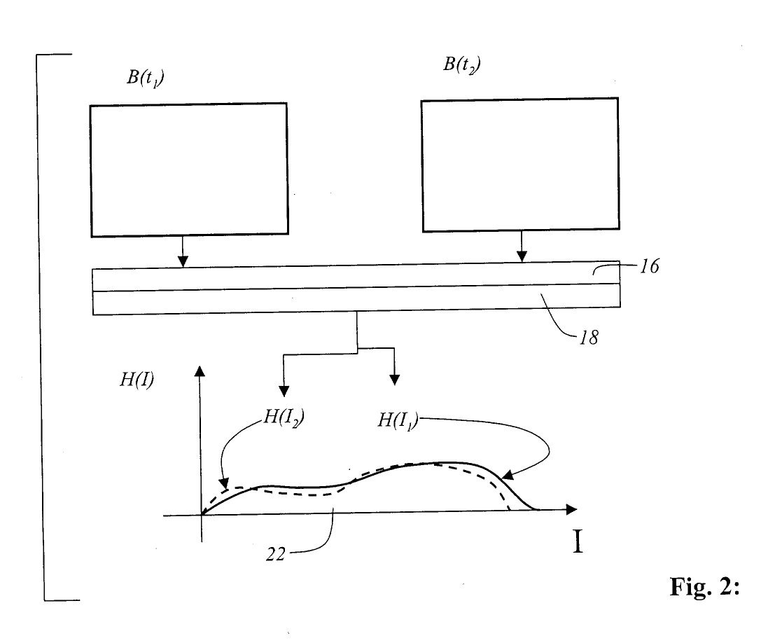

An embodiment of a process implemented in control and processing unit 16 is shown schematically in FIG. 2. Pixel intensities of two sequentially captured images are displayed as a histogram. A first image B(t₁) is captured at time t₁ and a second image B(t₂) is captured at time t₂. The signals corresponding to the images are fed to control and processing unit 16 and to computer 18. The measured pixel intensities of the first and second images B(t₁) and B(t₂) are plotted as a histogram 22. The abscissa of each data point represents an intensity I and the ordinate represents the frequency of the intensity H(I). The measured pixel data (intensities H(I)) are sent to control and processing unit 16 and to computer 18 to run the necessary calculations. The process of plotting the intensity histograms is used to calculate the bleaching rate from the histogram data. A first histogram H(I₁) is obtained from the pixel intensities of the first image B(t₁) and a second histogram H(I₂) is obtained from the pixel intensities of the second image B(t₂). For each of the first and the second histograms H(I₁) and H(I₂), a center of gravity representing the average pixel intensity of every image B(t₁) and B(t₂) is calculated. Therefore, the existing scan parameters have to be taken into consideration. For example, detector 12 may be operated near the overflow region or near the registration limit. (Those facts are taken into account and displayed to the user.) The center of gravity I of a histogram is calculated according to equation (1):

$$I = \frac{\sum H ( I ) I}{\sum H ( I )} \qquad ( 1 )$$

The center of gravity I₁ of the first histogram H(I₁) of the first image B(t₁) may be at a different location as compared to the center of gravity I₂ of the second histogram H(I₂) of the second image B(t₂). A bleach factor B can be calculated from the shift of the center of gravity according to equation (2):

$$B = 1 - \frac{{I}_{1}}{{I}_{2}} \qquad ( 2 )$$

If the light intensity of a scan differs from one scan to the next, the center of gravity shift of a histogram allows one to calculate the saturation of the specimen dyes. To calculate the saturation of the specimen dyes, a previously calculated bleaching rate may be taken into account.

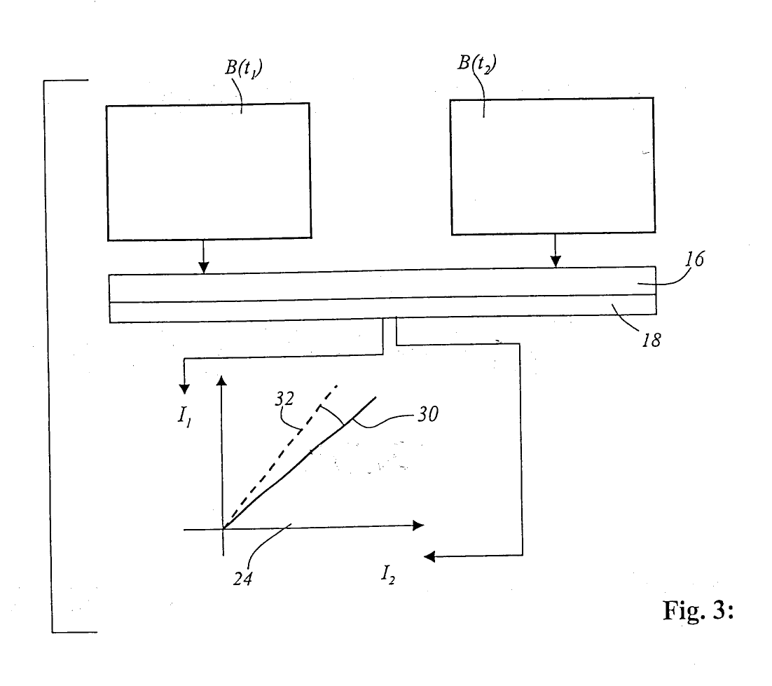

Another method of determining the bleaching rate and image noise is schematically illustrated in FIG. 3. The method compares the pixel intensity frequencies of sequentially captured a first image B(t₁) and a second image B(t₂). According to this method, the pixel intensities I₁ of the first image B(t₁) captured at time t₁ and the pixel intensities I₂ of the second image B(t₂) captured at time t₂ are determined and the corresponding image signals are fed to control and processing unit 16 and computer 18. The pixel intensities corresponding to the first and second images B(t₁) and B(t₂) are presented as a graph 24. The abscissa of that graph represents the pixel intensity I₂ of the second image B(t₂), the ordinate represents the intensity I₁ of first image B(t₁) at the same pixel. A graph corresponding to a sample without bleaching is a straight line 30 (solid) having a slope of 45° with respect to the abscissa. In contrast, a sample with bleaching produces a straight line 32 (dashed), having a slope larger than 45° with respect to the abscissa. It has to be noted, of course, that lines 30 and 32 can be produced only in a case of perfect measurements, while in reality the pixel intensity measurements are affected by noise.

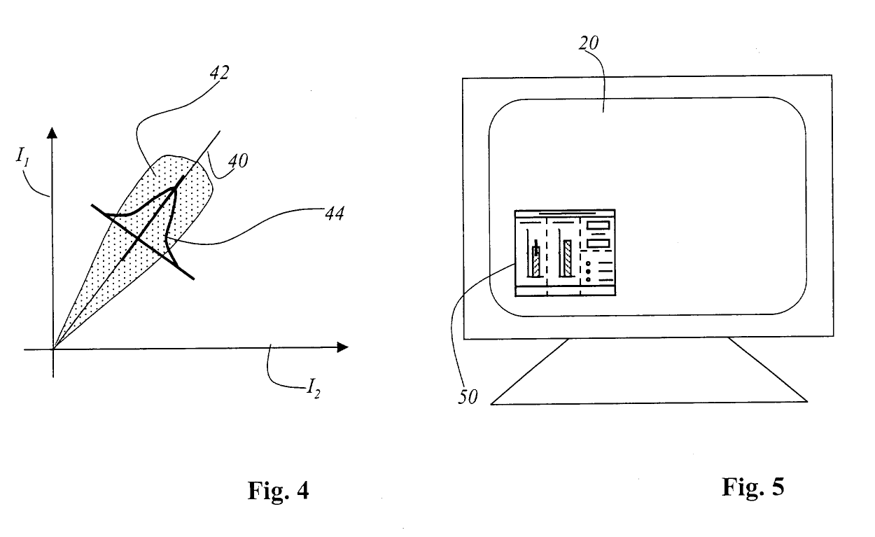

A method for determining the image background noise is schematically illustrated in FIG. 4. A straight line 40 corresponds to an ideal case with no noise. In reality the intensity pair data (I₁,I₂) corresponding to the pixel intensities I₁ and I₂ of the two images B(t₁) and B(t₂) are scattered around straight line 40. A distribution 42 of the intensity pair data (I₁,I₂) in a cross section perpendicular to straight line 40 can be related to the actual degree of noise. In most cases distribution 42 is a Gauss or Poisson distribution 44. The standard deviation represents the average pixel noise, which is displayed to a user. In another embodiment of the invention the diagram shown in FIG. 4 is displayed to a user on display 20. According to the described method, a user can determine the existing noise from the width of distribution 42, plus, the user can directly determine the bleaching rate from the slope of distribution 42.

In one embodiment of the invention a user can adjust the scanning parameters of the microscope while observing the corresponding image quality parameters on display 20, as shown in FIG. 5. The parameters can be displayed as a graphical window 50 of any size located anywhere on the display.

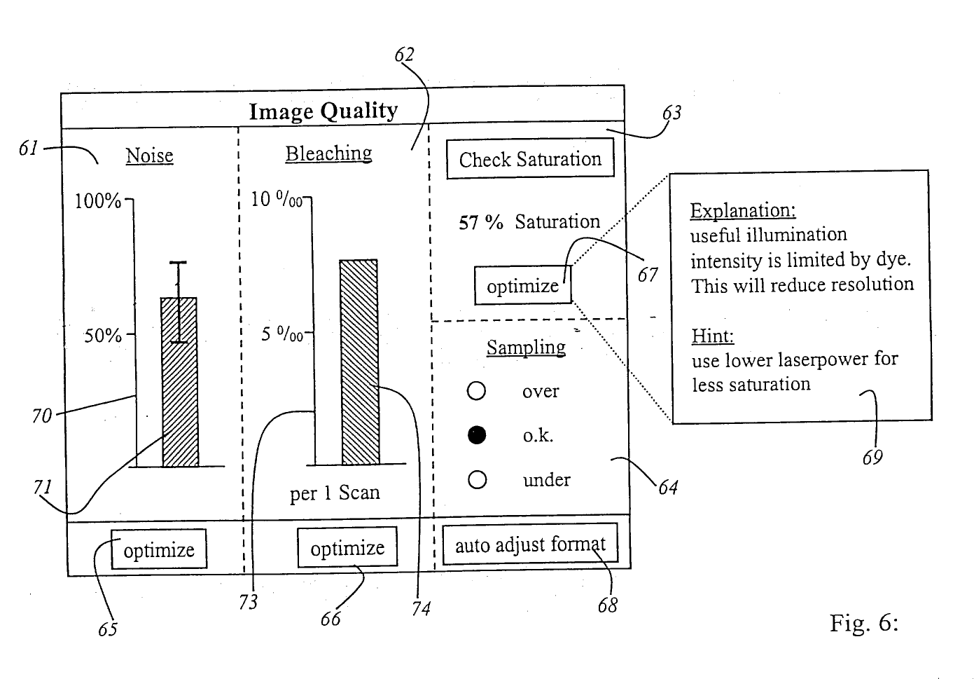

A more detailed view of graphical window 50 is shown in FIG. 6. Graphical window 50 displays the actual value of various parameters and a plurality of click buttons 65, 66, 67 and 68 in individual sections 61, 62, 63 and 64. The noise of the specimen is displayed as a diagram 70 in the first section 61. The height of a noise-bar 71 corresponds to the degree of noise within the range from 0% to 100% of the measured pixel intensities. The bleaching of the sample is displayed in the second section 62. The bleaching is presented as a diagram 73 in which the height of a bleaching-bar 74 corresponds to the degree of a bleaching within the range from 0% to 10% per 1 scan of the scanning beam across the specimen. The saturation of the sample is displayed in the third section 63 by a number showing the saturation in per cent. Click button 67 is also displayed in the third section 63 of the graphical window 50. Click button 67 has an “optimize” label which opens an additional window 69. Additional window 69 provides the user with an explanation and a hint regarding how to adjust the parameters to a lower level of saturation. In a particular embodiment shown in FIG. 6, the explanation reads as “Useful illumination intensity is limited by the dye. This will reduce resolution.” and the hint reads as “Use lower power for less saturation.” The sampling settings of the specimen are monitored and displayed in the fourth section 64. The current sampling setting is displayed as a highlighted button 64a. The sampling settings reflect three possible sampling rates: oversampling, o.k. an undersampling. Below the first section 61 is a first click button 65 for adjusting the microscope settings to optimize the noise/signal ratio. Below the second section 62 is a second click button 66 for setting and maintaining the optimal bleaching of the specimen from one scan to another. Below the fourth section 64 is a fourth click button 68 for automatically adjusting all of the parameters necessary to capture a good quality specimen image.

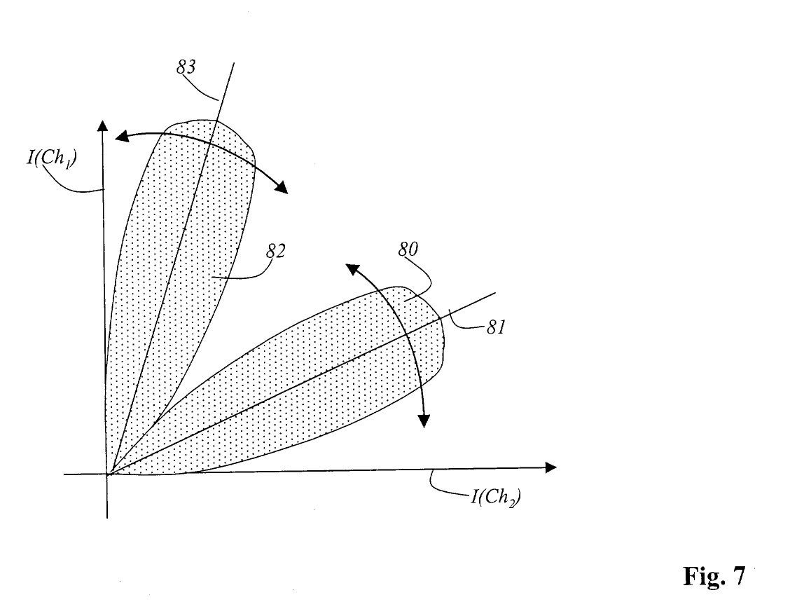

FIG. 7 illustrates a cross talk between two detection channels. The abscissa shows a intensity I(Ch₁) of a signal generated by a first spectral detection channel and the ordinate shows an intensity I(Ch₂) of a signal generated by a second detection channel. When there is no cross talk between the two channels, a first distribution 80 defining a first line 81 and a second distribution 82 defining a second line 83 are observed. A cross talk, for example, from the second channel to the first channel will rotate the first spectral detection channel away from the abscissa, as shown by arrows in FIG. 7. The graph of FIG. 7 can be shown to a user on display 20 to allow the user to view a possible cross talk.

The present invention has been described in detail with particular reference to the illustrated embodiments thereof, but it is to be understood that variations and modifications can be practiced without departing from the spirit and scope of the invention.

What is claimed is:

1. A system for guiding a user of a scanning microscope, the system comprising:
a scanning device for scanning a specimen with a light beam in a pixel-by-pixel fashion and generating a position signal of a pixel;
a first electrical signal proportional to the light received from the specimen and corresponding to the position signal;
a control and processing unit for receiving and digitizing the position signal and the first electrical signal, and for processing the position signal and the first electrical signal to obtain pixel intensities corresponding to at least two sequentially captured images of the specimen;
a computer for processing the pixel intensities corresponding to at least two images of the specimen and calculating one or more image quality parameters; and
a display unit for providing one or more image quality parameters to the user.

2. The system of claim 1, further comprising an illumination system for generating the light beam.

3. The system of claim 2, wherein the light beam is a laser beam.

4. The system of claim 1, wherein the control and processing unit comprises a plurality of field programmable gate arrays.

5. The system of claim 1, wherein the control and processing unit is a digital signal processor.

6. The system of claim 1, further comprising a detector for detecting light received from the specimen and converting it into the first electrical signal.

7. The system of claim 6, wherein one or more image quality parameters are a bleaching rate of the specimen, a bleaching rate of sample dyes, image noise, over- and undersampling, over- and underflow of the detector, saturation, a scanning rate and a size of a scanned area of the specimen.

8. The system of claim 1, wherein said display unit includes a graphical window having one or more click buttons allowing the user to optimize one or more image quality parameters.

9. The system of claim 1, wherein the light received from the specimen is fluorescent light.

10. The system of claim 9, further comprising a multi spectral detector for detecting the fluorescent light.

11. The system of claim 1, wherein the light received from the specimen is reflected light.

12. A scanning microscopy system comprising:
a illumination source for generating a light beam;
optical means for directing the light beam to a specimen;
a scanning device for scanning a specimen with the light beam in a pixel-by-pixel fashion and generating a position signal of a pixel;
at least one detector for detecting the light corresponding to the position signal received from the specimen and converting the light into a first signal;
means for receiving, digitizing and processing the position signal and the first signal to obtain pixel intensities corresponding to at least two sequentially captured images of the specimen and to process the pixel intensities to calculate one or more image quality parameters; and
a display unit for visualizing one or more image quality parameters.

13. The system of claim 12, wherein the means for receiving, digitizing and processing comprise a control and processing unit.

14. The system of claim 12, wherein the means for receiving, digitizing and processing comprise a computer.

15. The system of claim 13, wherein the control and processing unit is a digital signal processor.

16. The system of claim 12, wherein the light beam is a laser beam.

17. The system of claim 13, wherein the control and processing unit comprises a plurality of field programmable gate arrays.

18. The system of claim 12, wherein one or more image quality parameters are a bleaching rate of the specimen, a bleaching rate of sample dyes, image noise, over- and undersampling, over- and underflow of the detector, saturation, a scanning rate and a size of a scanned area of the specimen.

19. The system of claim 12, wherein said display unit includes a graphical window having one or more click buttons allowing the user to optimize one or more image quality parameters.

20. The system of claim 12, wherein the light received from the specimen is fluorescent light.

21. The system of claim 20, further comprising a multi spectral detector for detecting the fluorescent light.

22. The system of claim 12, wherein the light received from the specimen is reflected light.

23. A method of providing one or more image quality parameters to a user of a scanning microscope having a scanning device, the method comprising:
using a scanning device to generate a position signal of a pixel by scanning the specimen with a light beam in a pixel-by-pixel fashion;
generating a first electrical signal corresponding to the pixel and proportional to the light received from the specimen;
providing at least a first and a second images corresponding to the first electrical signal and the position signal;
converting the first electrical signal and the position signal into digital signals;
using the digital signals to obtain pixel intensities corresponding to at least the first and the second sequentially captured images of the specimen; and
processing the pixel intensities corresponding to at least the first and the second images of the specimen to calculate one or more image quality parameters and provide one or more image quality parameters to the user.

24. The method of claim 23, further comprising providing a display unit to enable the user to view one or more image quality parameters.

25. The method of claim 23, wherein processing the pixel intensities comprises plotting a first intensity histogram corresponding to the first image and a second intensity histogram corresponding to the second image, using the first intensity histogram and the second intensity histogram to obtain one or more image quality parameter.

26. A method of providing one or more image quality parameters to a user of a scanning microscope having a scanning device, the method comprising:
providing at least a first and a second images by providing a first electrical signal corresponding to light reflected from a specimen and providing a position signal generated by the scanning device;
converting the first electrical signal and the position signal into digital signals;
using the digital signals to obtain pixel intensities corresponding to at least the first and the second images of the specimen; and
processing the pixel intensities corresponding to at least the first and the second images of the specimen to calculate one or more image quality parameters and provide one or more image quality parameters to the user, wherein processing the pixel intensities comprises plotting a first intensity histogram corresponding to the first image and a second intensity histogram corresponding to the second image, using the first intensity histogram and the second intensity histogram to obtain one or more image quality parameter, and wherein one or more image quality parameters is a bleaching rate of the specimen.

27. A method of providing one or more image quality parameters to a user of a scanning microscope having a scanning device, the method comprising:
providing at least a first and a second images by providing a first electrical signal corresponding to light reflected from a specimen and providing a position signal generated by the scanning device;
converting the first electrical signal and the position signal into digital signals;
using the digital signals to obtain pixel intensities corresponding to at least the first and the second images of the specimen; and
processing the pixel intensities corresponding to at least the first and the second images of the specimen to calculate one or more image quality parameters and provide one or more image quality parameters to the user, wherein processing the pixel intensities further comprises providing intensity pairs, I₁, I_{2,} corresponding to the same pixel of the first image and the second image and using the intensity pairs, I₁, I_{2,} to obtain one or more image quality parameters.

28. The method of claim 27, wherein providing intensity pairs, I₁, I_{2,} further comprises plotting a distribution of the intensity pairs and determining a standard deviation of the intensity pairs.

29. The method of claim 28, wherein one or more image quality parameters are image noise and a bleaching rate.
